(19) United States
(12) Patent Application Publication
(10) Pub. No.: US 2023/0125844 A1
(43) Pub. Date: Apr. 27, 2023

(54) ULTRASONIC TRANSDUCER ARRAY COMBINATION AND ULTRASONIC IMAGING SYSTEM THEREOF

(71) Applicant: QISDA CORPORATION, Taoyuan City (TW)

(72) Inventors: Ping-Yang Liu, Tainan City (TW); Hsin-Che Hsieh, Taoyuan City (TW)

(73) Assignee: QISDA CORPORATION, Taoyuan City (TW)

(21) Appl. No.: 17/585,599

(22) Filed: Jan. 27, 2022

(30) Foreign Application Priority Data
Oct. 27, 2021 (CN) 202111255533.0

(51) Int. Cl. G01S 7/521; G01S 15/89

(52) U.S. Cl. CPC G01S 7/521; G01S 15/89; G01S 7/524

(57) ABSTRACT

An ultrasonic transducer array combination includes a casing and first, second, and third linear ultrasonic transducer arrays. The casing includes a first-layer housing, a second-layer housing, and a third-layer housing. The first-layer housing, the second-layer housing, and the third-layer housing are connected to each other in a stacked manner and have first, second, and third mounting surfaces in a z-shaped arrangement, respectively. The first linear ultrasonic transducer array is disposed corresponding to the first mounting surface in the first-layer housing. The second linear ultrasonic transducer array is disposed corresponding to the second mounting surface in the second-layer housing. The third linear ultrasonic transducer array is disposed corresponding to the third mounting surface in the third-layer housing, to make the first, second, and third linear ultrasonic transducer arrays spaced away from each other in the z-shaped arrangement.

### BACKGROUND OF THE INVENTION

### 1. Field of the Invention

The present invention relates to an ultrasonic transducer array combination and an ultrasonic imaging system thereof, and more specifically, to an ultrasonic transducer array combination capable of efficiently expanding a measuring range and an ultrasonic imaging system thereof.

### 2. Description of the Prior Art

Since ultrasound does not destroy material structure and harm living thing, an underwater ultrasonic device is in widespread use for the field of underwater measurement. The conventional underwater ultrasonic device for a wide-angle measuring range essentially consists of a plurality of ultrasonic transducers, each of which transmits and receives ultrasound individually. In other words, a wide-angle measuring range of the conventional underwater ultrasonic device is formed by measuring ranges of the plurality of ultrasonic transducers. However, when the ultrasonic transducers are spliced together, a lot of blind spots may be formed between the ultrasonic transducers, such that the accuracy of measurement may be influenced.

### SUMMARY OF THE INVENTION

The present invention provides an ultrasonic transducer array combination including a casing, a first linear ultrasonic transducer array, a second linear ultrasonic transducer array, and a third linear ultrasonic transducer array. The casing includes a first-layer housing, a second-layer housing, and a third-layer housing. The first-layer housing, the second-layer housing, and the third-layer housing are connected to each other in a stacked manner and have a first mounting surface, a second mounting surface, and a third mounting surface, respectively. The first mounting surface, the second mounting surface, and the third mounting surface are in a z-shaped arrangement. The first linear ultrasonic transducer array is disposed corresponding to the first mounting surface and disposed in the first-layer housing. The second linear ultrasonic transducer array is disposed corresponding to the second mounting surface and disposed in the second-layer housing. The third linear ultrasonic transducer array is disposed corresponding to the third mounting surface and disposed in the third-layer housing, to make the first linear ultrasonic transducer array, the second linear ultrasonic transducer array, and the third linear ultrasonic transducer array spaced away from each other and arranged in the z-shaped arrangement.

The present invention further provides an ultrasonic imaging system including an ultrasonic transducer array combination, an ultrasonic controller, and a display device. The ultrasonic transducer array combination includes a casing, a first linear ultrasonic transducer array, a second linear ultrasonic transducer array, and a third linear ultrasonic transducer array. The casing includes a first-layer housing, a second-layer housing, and a third-layer housing. The first-layer housing, the second-layer housing, and the third-layer housing are connected to each other in a stacked manner and have a first mounting surface, a second mounting surface, and a third mounting surface, respectively. The first mounting surface, the second mounting surface, and the third mounting surface are in a z-shaped arrangement. The first linear ultrasonic transducer array is disposed corresponding to the first mounting surface and disposed in the first-layer housing. The second linear ultrasonic transducer array is disposed corresponding to the second mounting surface and disposed in the second-layer housing. The third linear ultrasonic transducer array is disposed corresponding to the third mounting surface and disposed in the third-layer housing, to make the first linear ultrasonic transducer array, the second linear ultrasonic transducer array, and the third linear ultrasonic transducer array spaced away from each other and arranged in the z-shaped arrangement. The ultrasonic controller is coupled to the ultrasonic transducer array combination for controlling the first linear ultrasonic transducer array, the second linear ultrasonic transducer array and the third linear ultrasonic transducer array to perform ultrasonic measurement. The display device is coupled to the ultrasonic controller for receiving at least one ultrasonic signal transmitted from the first linear ultrasonic transducer array, the second linear ultrasonic transducer array and the third linear ultrasonic transducer array to display an ultrasonic image after the ultrasonic measurement is performed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an ultrasonic imaging system according to an embodiment of the present invention.

FIG. 2 is a diagram of an ultrasonic transducer array combination in FIG. 1.

FIG. 3 is an internal diagram of the ultrasonic transducer array combination in FIG. 2.

### DETAILED DESCRIPTION

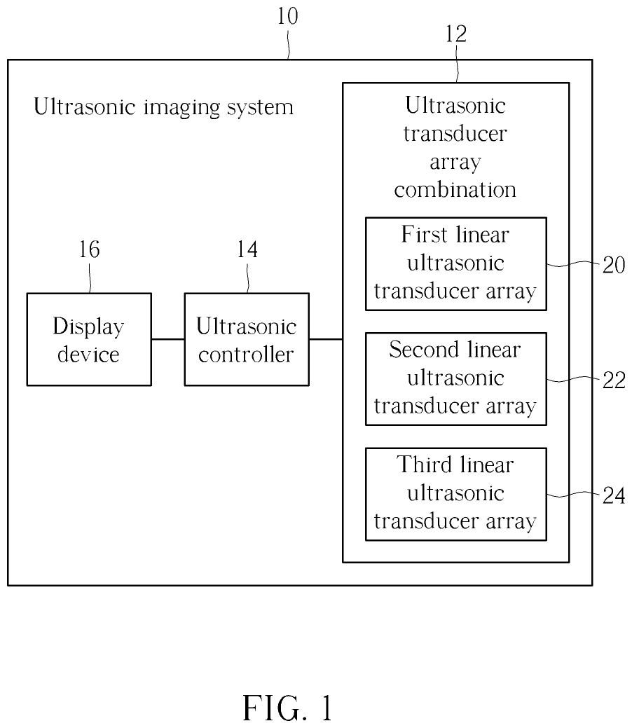

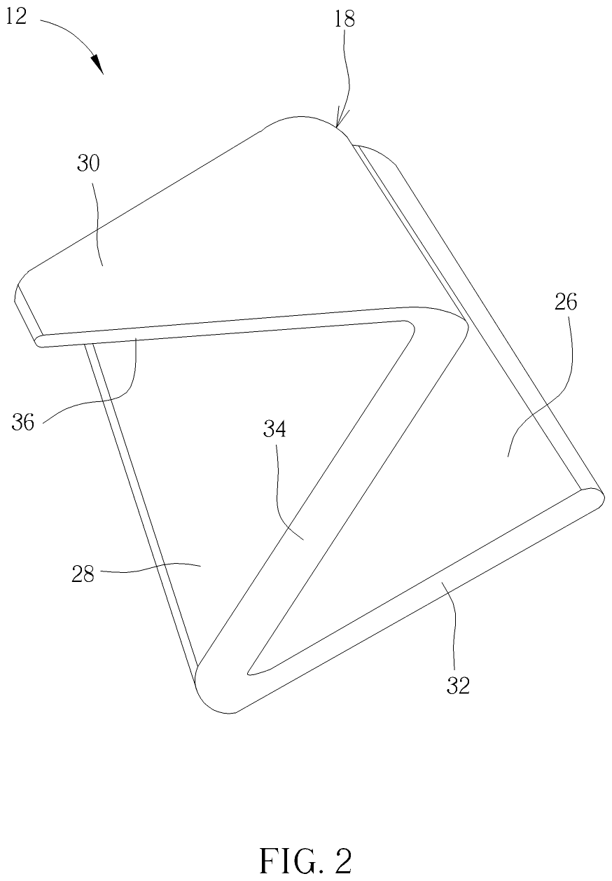

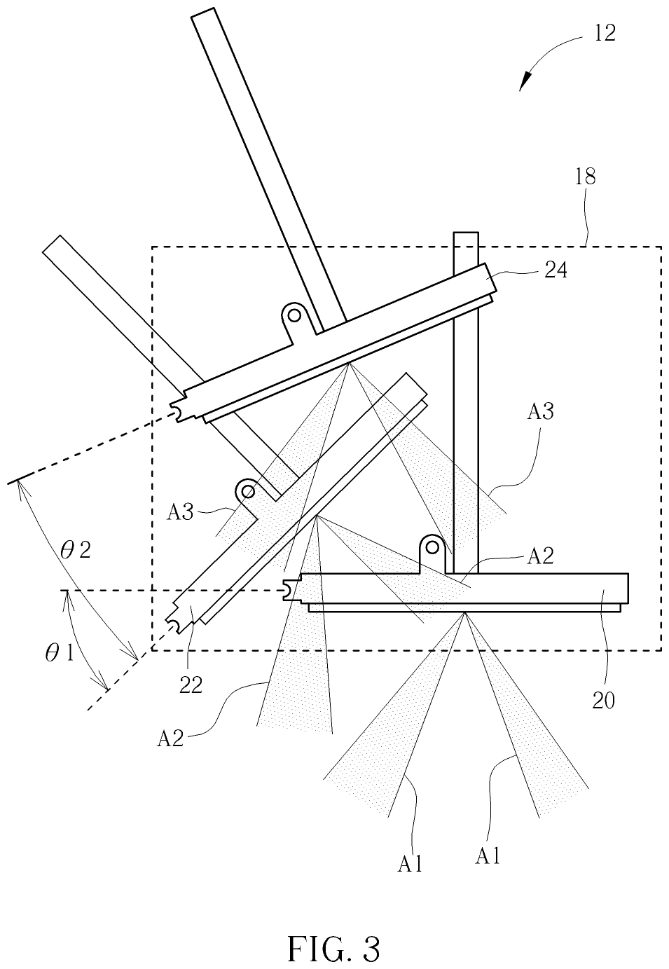

Please refer to FIG. 1, FIG. 2, and FIG. 3. FIG. 1 is a functional block diagram of an ultrasonic imaging system 10 according to an embodiment of the present invention. FIG. 2 is a diagram of an ultrasonic transducer array combination 12 in FIG. 1. FIG. 3 is an internal diagram of the ultrasonic transducer array combination 12 in FIG. 2. The ultrasonic imaging system 10 could be preferably disposed under a boat or a rudder of the boat for underwater object (e.g. fish or underwater terrain) measurement via ultrasonic reflection, or could be manufactured as an independent component for a water surface activity (e.g. ice fishing), but not limited thereto.

As shown in FIGS. 1-3, the ultrasonic imaging system 10 includes the ultrasonic transducer array combination 12, an ultrasonic controller 14, and a display device 16. The ultrasonic transducer array combination 12 includes a casing 18, a first linear ultrasonic transducer array 20, a second linear ultrasonic transducer array 22, and a third linear ultrasonic transducer array 24. The ultrasonic controller 14 is electrically connected to the ultrasonic transducer array combination 12 for controlling the first linear ultrasonic transducer array 20, the second linear ultrasonic transducer array 22, and the third linear ultrasonic transducer array 24 to perform ultrasonic measurement. The display device 16 is electrically connected to the ultrasonic controller 14 for receiving at least one ultrasonic signal transmitted from the first linear ultrasonic transducer array 20, the second linear ultrasonic transducer array 22, and the third linear ultrasonic transducer array 24 to display a corresponding ultrasonic image after the ultrasonic measurement is performed. To be noted, a phased array ultrasonic transducer is also a linear ultrasonic transducer array mentioned in the invention, and the related description for the ultrasonic signal transceiving design of the ultrasonic controller 14 and the ultrasonic imaging design of the display device 16 is commonly seen in the prior art and omitted herein.

To be more specific, the casing 18 includes a first-layer housing 26, a second-layer housing 28, and a third-layer housing 30. The second-layer housing 28 and the third-layer housing 30 could be preferably located at a same side of the first-layer housing 26. The first-layer housing 26, the second-layer housing 28, and the third-layer housing 30 are stacked sequentially to cooperatively form the casing 18 with a quadrilateral contour (as shown in FIG. 2, but not limited thereto) and have a first mounting surface 32, a second mounting surface 34, and a third mounting surface 36, respectively. The first mounting surface 32, the second mounting surface 34, and the third mounting surface 36 are in a z-shaped arrangement. The first linear ultrasonic transducer array 20 is disposed corresponding to the first mounting surface 32 and disposed in the first-layer housing 26 (e.g. attaching to the first mounting surface 32, but not limited thereto) . The second linear ultrasonic transducer array 22 is disposed corresponding to the second mounting surface 34 and disposed in the second-layer housing 28 (e.g. attaching to the second mounting surface 34, but not limited thereto). The third linear ultrasonic transducer array 24 is disposed corresponding to the third mounting surface 36 and disposed in the third-layer housing 30 (e.g. attaching to the third mounting surface 36, but not limited thereto). As such, the first linear ultrasonic transducer array 20, the second linear ultrasonic transducer array 22, and the third linear ultrasonic transducer array 24 can be spaced away from each other and arranged in the z-shaped arrangement.

Furthermore, in this embodiment, an included angle el is formed between the first linear ultrasonic transducer array 20 and the second linear ultrasonic transducer array 22, and an included angle θ2 is formed between the second linear ultrasonic transducer array 22 and the third linear ultrasonic transducer array 24. The included angle θ1 and the included angle θ2 could be preferably between 10° and 30°. Moreover, in this embodiment, the first linear ultrasonic transducer array 20, the second linear ultrasonic transducer array 22, and the third linear ultrasonic transducer array 24 are used to transmit a plurality of ultrasonic signals respectively and receive a plurality of reflection signals corresponding to the plurality of ultrasonic signals respectively. The first linear ultrasonic transducer array 20 could preferably have at least one first measuring range Al (two shown in FIG. 3, but not limited thereto) , the second linear ultrasonic transducer array 22 could preferably have at least one second measuring range A2 (two shown in FIG. 3, but not limited thereto), and the third linear ultrasonic transducer array 24 could preferably have at least one third measuring range A3 (two shown in FIG. 3, but not limited thereto). Accordingly, as shown in FIG. 3, the first measuring range A1, the second measuring range A2, and the third measuring range A3 can form a wide-angle measuring range (e.g. 120°, but not limited thereto) cooperatively. To be noted, the number of the linear ultrasonic transducer arrays could be increased correspondingly according to the practical application of the ultrasonic transducer array combination of the present invention for wide-angle measuring range adjustment.

Via the aforesaid designs, for example, the ultrasonic transducer array combination 12 could be fixed to a boat via the casing 18 and the first mounting surface 32 could be adjusted to be substantially parallel to a horizontal plane, so that the ultrasonic transducer array combination 12 can perform underwater ultrasonic measurement on living things (e.g. fish) close to the horizontal plane. Furthermore, in practical application, a user can make the second mounting surface 34 face level down such that the ultrasonic transducer array combination 12 can provide a symmetrical ultrasonic measuring range for subsequent fixed point fishing. Moreover, the ultrasonic transducer array combination 12 could adopt a rotatable mechanical design. In general, the ultrasonic transducer array combination 12 is used to face downward for underwater image measurement. When it comes to fish tracking, the user can rotate the ultrasonic transducer array combination 12 upward to make the first ultrasonic transducer array 20 closer to the horizontal plane, so as to increase an ultrasonic imaging range of the ultrasonic transducer array combination 12 close to the horizontal plane. As such, the ultrasonic transducer array combination 12 can perform ultrasonic measurement on waters in front of the boat or in a moving direction of the boat.

In summary, since the present invention adopts the design in which the first linear ultrasonic transducer array, the second linear ultrasonic transducer array, and the third linear ultrasonic transducer array are spaced away from each other in a stacked manner and cooperatively form the z-shaped arrangement, to generate the wide-angle ultrasonic measurement effect, the present invention can efficiently solve the prior art problem that a lot of blind spots maybe formed between the ultrasonic transducers when the ultrasonic transducers are spliced together, so as to greatly improve the ultrasonic measuring range and accuracy of measurement of the ultrasonic transducer array combination.

It should be mentioned that the casing design of the ultrasonic transducer array combination is not limited to FIG. 2, in which the second-layer housing 28 and the third-layer housing 30 are located at the same side of the first-layer housing 26 and the first mounting surface 32 is a bottom surface of the first-layer housing 26, to improve the design flexibility of the ultrasonic transducer array combination of the present invention. In other words, all casing designs in which the first linear ultrasonic transducer array, the second linear ultrasonic transducer array, and the third linear ultrasonic transducer array are spaced away from each other in a stacked manner and cooperatively form the z-shaped arrangement may fall within the scope of the present invention. For example, in another embodiment, the second-layer housing 28 and the third-layer housing 30 could be located at a front side and a rear side of the first-layer housing 26, respectively, or the first mounting surface 32 could be a top surface of the first-layer housing 26. The related description could be reasoned by analogy according to the aforesaid embodiment and omitted herein. As for which design is adopted, it depends on the practical application of the ultrasonic transducer array combination of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An ultrasonic transducer array combination comprising:
a casing comprising a first-layer housing, a second-layer housing, and a third-layer housing, the first-layer housing, the second-layer housing, and the third-layer housing being connected to each other in a stacked manner and having a first mounting surface, a second mounting surface, and a third mounting surface respectively, the first mounting surface, the second mounting surface, and the third mounting surface being in a z-shaped arrangement;
a first linear ultrasonic transducer array disposed corresponding to the first mounting surface and disposed in the first-layer housing;
a second linear ultrasonic transducer array disposed corresponding to the second mounting surface and disposed in the second-layer housing; and
a third linear ultrasonic transducer array disposed corresponding to the third mounting surface and disposed in the third-layer housing, to make the first linear ultrasonic transducer array, the second linear ultrasonic transducer array, and the third linear ultrasonic transducer array spaced away from each other and arranged in the z-shaped arrangement.

2. The ultrasonic transducer array combination of claim 1, wherein the first-layer housing, the second-layer housing, and third-layer housing are connected to each other in a stacked manner to cooperatively form the casing with a quadrilateral contour.

3. The ultrasonic transducer array combination of claim 1, wherein an included angle is formed between the first linear ultrasonic transducer array and the second linear ultrasonic transducer array, and the included angle is between 10° and 30°.

4. The ultrasonic transducer array combination of claim 1, wherein an included angle is formed between the second linear ultrasonic transducer array and the third linear ultrasonic transducer array, and the included angle is between 10° and 30°.

5. The ultrasonic transducer array combination of claim 1, wherein the first mounting surface is substantially parallel to a horizontal plane.

6. The ultrasonic transducer array combination of claim 1, wherein the second-layer housing and the third-layer housing are located at a same side of the first-layer housing, and the first-layer housing, the second-layer housing and the third-layer housing are stacked sequentially.

7. The ultrasonic transducer array combination of claim 1, wherein the second-layer housing and the third-layer housing are located at two sides of the first-layer housing, respectively.

8. The ultrasonic transducer array combination of claim 1, wherein the first mounting surface is a top or bottom surface of the first-layer housing.

9. The ultrasonic transducer array combination of claim 1, wherein the first linear ultrasonic transducer array has at least one first measuring range, the second linear ultrasonic transducer array has at least one second measuring range, the third linear ultrasonic transducer array has at least one third measuring range, and the at least one first measuring range, the at least one second measuring range and the at least one third measuring range form a wide-angle measuring range cooperatively.

10. The ultrasonic transducer array combination of claim 1, wherein the ultrasonic transducer array combination is fixed to a boat via the casing for underwater ultrasonic measurement.

11. An ultrasonic imaging system comprising:
an ultrasonic transducer array combination comprising:
a casing comprising a first-layer housing, a second-layer housing, and a third-layer housing, the first-layer housing, the second-layer housing, and the third-layer housing being connected to each other in a stacked manner and having a first mounting surface, a second mounting surface, and a third mounting surface respectively, the first mounting surface, the second mounting surface, and the third mounting surface being in a z-shaped arrangement;
a first linear ultrasonic transducer array disposed corresponding to the first mounting surface and disposed in the first-layer housing;
a second linear ultrasonic transducer array disposed corresponding to the second mounting surface and disposed in the second-layer housing; and
a third linear ultrasonic transducer array disposed corresponding to the third mounting surface and disposed in the third-layer housing, to make the first linear ultrasonic transducer array, the second linear ultrasonic transducer array, and the third linear ultrasonic transducer array spaced away from each other and arranged in the z-shaped arrangement;
an ultrasonic controller coupled to the ultrasonic transducer array combination for controlling the first linear ultrasonic transducer array, the second linear ultrasonic transducer array and the third linear ultrasonic transducer array to perform ultrasonic measurement; and
a display device coupled to the ultrasonic controller for receiving at least one ultrasonic signal transmitted from the first linear ultrasonic transducer array, the second linear ultrasonic transducer array and the third linear ultrasonic transducer array to display an ultrasonic image after the ultrasonic measurement is performed.

12. The ultrasonic imaging system of claim 11, wherein the first-layer housing, the second-layer housing, and third-layer housing are connected to each other in a stacked manner to cooperatively form the casing with a quadrilateral contour.

13. The ultrasonic imaging system of claim 11, wherein an included angle is formed between the first linear ultrasonic transducer array and the second linear ultrasonic transducer array, and the included angle is between 10° and 30°.

14. The ultrasonic imaging system of claim 11, wherein an included angle is formed between the second linear ultrasonic transducer array and the third linear ultrasonic transducer array, and the included angle is between 10° and 30°.

15. The ultrasonic imaging system of claim 11, wherein the first mounting surface is substantially parallel to a horizontal plane.

16. The ultrasonic imaging system of claim 11, wherein the second-layer housing and the third-layer housing are located at a same side of the first-layer housing, and the first-layer housing, the second-layer housing and the third-layer housing are stacked sequentially.

17. The ultrasonic imaging system of claim 11, wherein the second-layer housing and the third-layer housing are located at two sides of the first-layer housing, respectively.

18. The ultrasonic imaging system of claim 11, wherein the first mounting surface is a top or bottom surface of the first-layer housing.

19. The ultrasonic imaging system of claim 11, wherein the first linear ultrasonic transducer array has at least one first measuring range, the second linear ultrasonic transducer array has at least one second measuring range, the third linear ultrasonic transducer array has at least one third measuring range, and the at least one first measuring range, the at least one second measuring range and the at least one third measuring range form a wide-angle measuring range cooperatively.

20. The ultrasonic imaging system of claim 11, wherein the ultrasonic transducer array combination is fixed to a boat via the casing for underwater ultrasonic measurement.
